(19) United States
(12) Patent Application Publication
(10) Pub. No.: US 2026/0242635 A1
(43) Pub. Date: Aug. 20, 2026

(54) ETCHANT PRETREATMENT SOLUTIONS AND RELATED METHODS

(71) Applicant: ENTEGRIS, INC., Billerica, MA (US)

(72) Inventor: Qihui Qian, Southbury, CT (US)

(21) Appl. No.: 19/544,962

(22) Filed: Feb. 19, 2026

Related U.S. Application Data
(60) Provisional application No. 63/760,859, filed on Feb. 20, 2025.

(51) Int. Cl. C09D 183/06; C09D 7/65; C09D 183/08

(52) U.S. Cl. CPC C09D 183/06; C09D 7/65; C09D 183/08

(57) ABSTRACT

Pretreatment compositions for selectively etching silicon germanium are provided. The pretreatment compositions may comprise a water, an acid component, an inhibitor, and 1% to 20% by weight of a silane coupling agent based on a total weight of the pretreatment composition. When a substrate comprising a silicon component and a silicon germanium component are contacted with the pretreatment composition and subsequently contacted with an etchant composition, the etchant composition exhibits a selectivity of the silicon germanium component to the silicon component of at least 30. Related kits and related methods are also provided.

### CROSS-REFERENCE TO RELATED APPLICATIONS

This application claims the benefit under 35 USC 119 of U.S. Provisional Patent Application No. 63/760,859, filed Feb. 20, 2025, the disclosure of which is hereby incorporated herein by reference in its entirety.

### FIELD

The present disclosure relates to etchant pretreatment solutions for selective etching and related methods.

### BACKGROUND

Manufacture of microelectronic devices involves material removal via etching. The removal of these materials via etching can also result in the undesirable removal of other materials.

### SUMMARY

Some embodiments relate to a pretreatment composition. In some embodiments, the pretreatment composition comprises a water. In some embodiments, the pretreatment solution comprises an acid component. In some embodiments, the pretreatment solution comprises an inhibitor. In some embodiments, the pretreatment solution comprises 1% to 20% by weight of a silane coupling agent based on a total weight of the pretreatment composition. In some embodiments, when a substrate comprising a silicon component and a silicon germanium component is contacted with the pretreatment composition and subsequently contacted with an etchant composition, the etchant composition exhibits a selectivity of the silicon germanium component to the silicon component of at least 30.

Some embodiments relate to a kit for selectively etching silicon germanium. In some embodiments, the kit comprises a pretreatment composition. In some embodiments, the pretreatment composition comprises a water. In some embodiments, the pretreatment solution comprises an acid component. In some embodiments, the pretreatment solution comprises an inhibitor. In some embodiments, the pretreatment solution comprises 1% to 20% by weight of a silane coupling agent based on a total weight of the pretreatment composition. In some embodiments, the kit comprises an etchant composition. In some embodiments, when a substrate comprising a silicon component and a silicon germanium component is contacted with the pretreatment composition and subsequently contacted with the etchant composition, the etchant composition exhibits a selectivity of the silicon germanium component to the silicon component of at least 30.

Some embodiments relate to a method for selectively etching silicon germanium. In some embodiments, the method comprises obtaining a pretreatment composition. In some embodiments, the pretreatment composition comprises a water. In some embodiments, the pretreatment solution comprises an acid component. In some embodiments, the pretreatment solution comprises an inhibitor. In some embodiments, the pretreatment solution comprises 1% to 20% by weight of a silane coupling agent based on a total weight of the pretreatment composition. In some embodiments, the method comprises obtaining an etchant composition. In some embodiments, the method comprises contacting the pretreatment composition with a substrate comprising a silicon germanium component and a silicon component. In some embodiments, after contacting the substrate with the pretreatment composition, contacting the substrate with the etchant composition.

### BRIEF DESCRIPTION OF THE DRAWINGS

FIG. 1 is a flowchart of a method for selectively etching silicon germanium, according to some embodiments.

FIG. 2. Is a schematic diagram of the method for selectively etching silicon germanium, according to Example 1.

### DETAILED DESCRIPTION

Manufacture of microelectronic devices and fabrication of semiconductors can involve material removal via etching. Silicon germanium (SiGe) is an example of a material removed during the manufacture of microelectronic devices. For example, silicon germanium (SiGe) can be deposited as a layer on a substrate by chemical vapor deposition, among other vapor deposition processes. During the manufacture or fabrication process, the silicon germanium (SiGe) layer may be at least partially removed. Etchants may be useful for removing at least a portion of the silicon germanium (SiGe) layer. Current etchants, however, remove or otherwise damage other materials present, such as, for example and without limitation, silicon, in addition to removing silicon germanium (SiGe). The removal of or damage caused to these other materials—including silicon—is undesirable.

As used herein, “pretreatment” refers to treating a substrate before being contacted by an etchant composition. In some embodiments, the pretreatment composition does not substantially etch the substrate. In some embodiments, the pretreatment composition does not etch the substrate. In some embodiments, the pretreatment composition alters one or more components of the substrate. In some embodiments, the pretreatment composition alters one or more component of the substrate resulting in the subsequent etchant composition being at least one of more selective to one or more components of the substrate, etching one or more components of the substrate more effectively, or any combination thereof, as compared to an etchant composition used on the substrate without the pretreatment.

Some embodiments relate to etchant pretreatment compositions useful in the manufacture of microelectronics, including the fabrication of semiconductors. The pretreatment compositions may comprise a solution. In some embodiments, the pretreatment composition comprises a liquid solution. In some embodiments, the pretreatment composition comprises a liquid solution and at least one solid component. In some embodiments, the pretreatment composition comprises a slurry. In some embodiments, the pretreatment composition comprises a suspension. In some embodiments, the pretreatment composition comprises an emulsion. In some embodiments, the pretreatment composition comprises a solution of at least one dissolved component. In some embodiments, the pretreatment composition comprises any combination of the foregoing.

In some embodiments, the pretreatment composition comprises a water. In some embodiments, the water comprises a deionized water. In some embodiments, the water comprises a tap water. In some embodiments, the water comprises a filtered water.

In some embodiments, the pretreatment composition comprises at least 60% by weight of the water based on a total weight of the pretreatment composition. In some embodiments, the pretreatment composition comprises at least 65%, at least 70%, at least 75%, at least 80%, at least 85%, at least 90%, or at least 95% by weight of the water based on the total weight of the pretreatment composition.

In some embodiments, the pretreatment composition comprises 60% to 98%, or any range or subrange between 60% to 98%, by weight of the water based on the total weight of the pretreatment composition. In some embodiments, the pretreatment composition comprises 60% to 95%, 60% to 90%, 60% to 85%, 60% to 80%, 60% to 75%, 60% to 70%, 60% to 65%, 65% to 98%, 70% to 98%, 75% to 98%, 80% to 98%, 85% to 98%, 90% to 98%, or 95% to 98% by weight of the water based on the total weight of the pretreatment composition.

In some embodiments, the pretreatment composition an acid component. In some embodiments, the acid component comprises at least one of a hydrofluoric acid, a nitric acid, an acetic acid, a phosphoric acid, a citric acid, a peracetic acid, an oxalic acid, a tartaric acid, a perchloric acid, a formic acid, a sulfuric acid, a hydrobromic acid, a trifluoroacetic acid, or any combination thereof.

In some embodiments, the pretreatment composition comprises 0.1% to 10%, or range or subrange between 0.1% to 10%, by weight of the acid component based on the total weight of the pretreatment composition. In some embodiments, the pretreatment composition comprises 0.1% to 9%, 0.1% to 8%, 0.1% to 7%, 0.1% to 6%, 0.1% to 5%, 0.1% to 4%, 0.1% to 3%, 0.1% to 2%, 0.1% to 1%, 0.1% to 0.9%, 0.1% to 0.8%, 0.1% to 0.7%, 0.1% to 0.6%, 0.1% to 0.5%, 0.1% to 0.4%, 0.1% to 0.3%, 0.1% to 0.2%, 0.2% to 10%, 0.3% to 10%, 0.4% to 10%, 0.5% to 10%, 0.6% to 10%, 0.7% to 10%, 0.8% to 10%, 0.9% to 10%, 1% to 10%, 2% to 10%, 3% to 10%, 4% to 10%, 5% to 10%, 6% to 10%, 7% to 10%, 8% to 10%, or 9% to 10% by weight of the acid component based on the total weight of the pretreatment composition.

In some embodiments, the pretreatment composition has a pH of 4 to 7, or any range or subrange between 4 to 7. In some embodiments, the pretreatment composition has a pH of 4 to 6.5, 4 to 6, 4 to 5.5, 4 to 5, 4 to 4.5, 4.5 to 7, 5 to 7, 5.5 to 7, 6 to 7, or 6.5 to 7. In some embodiments, the acid component is present in the pretreatment composition in a sufficient amount as to result in the pretreatment composition having a pH of 4 to 7.

In some embodiments, the pretreatment composition comprises an inhibitor. In some embodiments, the inhibitor comprises at least one of a nitride inhibitor, an oxide inhibitor, or any combination thereof. In some embodiments, the inhibitor comprises at least one of a polyethyleneimine (PEI), a polyethylene, a polyvinylpyrrolidone, a silicic acid, a polyethylene glycol, a polypropylene glycol, a quaternary ammonium compound, a benzotriazole, a pyridine, a pyrazole, or any combination thereof.

In some embodiments, the pretreatment composition comprises 0.1% to 10%, or range or subrange between 0.1% to 10%, by weight of the inhibitor based on the total weight of the pretreatment composition. In some embodiments, the pretreatment composition comprises 0.1% to 9%, 0.1% to 8%, 0.1% to 7%, 0.1% to 6%, 0.1% to 5%, 0.1% to 4%, 0.1% to 3%, 0.1% to 2%, 0.1% to 1%, 0.1% to 0.9%, 0.1% to 0.8%, 0.1% to 0.7%, 0.1% to 0.6%, 0.1% to 0.5%, 0.1% to 0.4%, 0.1% to 0.3%, 0.1% to 0.2%, 0.2% to 10%, 0.3% to 10%, 0.4% to 10%, 0.5% to 10%, 0.6% to 10%, 0.7% to 10%, 0.8% to 10%, 0.9% to 10%, 1% to 10%, 2% to 10%, 3% to 10%, 4% to 10%, 5% to 10%, 6% to 10%, 7% to 10%, 8% to 10%, or 9% to 10% by weight of the inhibitor based on the total weight of the pretreatment composition.

In some embodiments, the pretreatment composition comprises a silane coupling agent. In some embodiments, the silane coupling agent comprises at least one functional group. In some embodiments, the at least one functional group comprises at least one of an alkyl, an alkoxy, a vinyl, an epoxy, a (meth)acryloxy, an amino, a ureido, an isocyanate, a mercapto, a carboxylic acid, or any combination thereof. In some embodiments, the silane coupling agent comprises a compound of the formula:
R—Si(OH)₂—O—Si(OH)₂—R, wherein R independently comprises an organic functional group. In some embodiments, the organic functional group comprises at least one of a carboxylic acid, an amino, a vinyl, an alkyl, a quaternary ammonium, an epoxy, an acryloxy, a methacryloxy, a ureido, an isocyanate, a mercapto, or any combination thereof.

In some embodiments, the silane coupling agent comprises at least one of a methyltrimethoxysilane (MTMS), a 1,3-dimethyltetramethoxydisiloxane (MTMS dimer), a dimethyldimethoxysilane, a methyltriethoxysilane, a dimethyldiethoxysilane, a trimethoxysilane, a methyldimethoxysilane, a di-isopropyldimethoxysilane, a methyldiethoxysilane, a vinylmethyldimethoxysilane, a divinyldimethoxysilane, a vinylmethyldiethoxysilane, a divinyldiethoxysilane, a vinyltrimethoxysilane, a vinyltriethoxysilane, a 2-(3,4 epoxycyclohexyl)ethyltrimethoxysilane, a 3-glycidoxypropyl methyldimethoxysilane, a 3-glycidoxypropyl trimethoxysilane, a 3-glycidoxypropyl methyldiethoxysilane, a 3-glycidoxypropyl triethoxysilane, a p-styryltrimethoxysilane, a 3-methacryloxypropyl methyldimethoxysilane, a 3-methacryloxypropyl trimethoxysilane, a 3-methacryloxypropyl methyldiethoxysilane, a 3-methacryloxypropyl triethoxysilane, a 3-acryloxypropyl trimethoxysilane, a N-2-(aminoethyl)-3-aminopropylmethyldimethoxysilane, a N-2-(aminoethyl)-3-aminopropyltrimethoxysilane, a 3-aminopropyltrimethoxysilane, a 3-aminopropyltriethoxysilane, a 3-triethoxysilyl-N-(1,3 dimethyl-butylidene) propylamine, a N-phenyl-3-aminopropyltrimethoxysilane, a 3-ureidopropyltrialkoxysilane a 3-isocyanatepropyltriethoxysilane, a tris-(trimethoxysilylpropyl) isocyanurate, a 3-mercaptopropylmethyldimethoxysilane, a 3-mercaptopropyltrimethoxysilane, a mercaptomethyltrimethoxysilane, a 7-octenyltrimethoxysilane, a carboxylic acid siloxane, a dicarboxylic acid siloxane, or any combination thereof.

In some embodiments, the pretreatment composition comprises 1% to 20%, or any range or subrange between 1% to 20%, by weight of the silane coupling agent based on a total weight of the pretreatment composition. In some embodiments, the pretreatment composition comprises 1% to 19%, 1% to 18%, 1% to 17%, 1% to 16%, 1% to 15%, 1% to 14%, 1% to 13%, 1% to 12%, 1% to 11%, 1% to 10%, 1% to 9%, 1% to 8%, 1% to 7%, 1% to 6%, 1% to 5%, 1% to 4%, 1% to 3%, 1% to 2%, 2% to 20%, 3% to 20%, 4% to 20%, 5% to 20%, 6% to 20%, 7% to 20%, 8% to 20%, 9% to 20%, 10% to 20%, 11% to 20%, 12% to 20%, 13% to 20%, 14% to 20%, 15% to 20%, 16% to 20%, 17% to 20%, 18% to 20%, or 19% to 20% by weight of the silane coupling agent based on the total weight of the pretreatment composition.

In some embodiments, the pretreatment composition comprises an oxidant. In some embodiments, the oxidant comprises at least one of hydrogen peroxide (H₂O₂), FeCl₃, FeF₃, Fe(NO₃)₃, Sr(NO₃)₂, CoF₃, MnF₃, oxone, (2KHSO₅·KHSO₄·K₂SO₄), nitric acid (HNO₃), ammonium peroxomonosulfate, ammonium chlorite (NH₄ClO₂), ammonium chlorate (NH₄ClO₃), ammonium iodate (NH₄IO₃), ammonium nitrate (NH₄NO₃), ammonium perborate (NH₄BO₃), ammonium perchlorate (NH₄ClO₄), ammonium periodate (NH₄IO₄), ammonium persulfate ((NH₄)₂S₂O₈), ammonium hypochlorite (NH₄ClO), ammonium tungstate ((NH₄)₁₀H₂(W₂O₇)), sodium persulfate (Na₂S₂O₈), sodium hypochlorite (NaClO), sodium perborate, potassium iodate (KIO₃), potassium permanganate (KMnO₄), potassium persulfate (K₂S₂O₈), potassium hypochlorite (KClO), tetramethylammonium chlorite ((N(CH₃)₄)ClO₂), tetramethylammonium chlorate ((N(CH₃)₄)ClO₃), tetramethylammonium iodate ((N(CH₃)₄)IO₃), tetramethylammonium perborate ((N(CH₃)₄)BO₃), tetramethylammonium perchlorate ((N(CH₃)₄)ClO₄), tetramethylammonium periodate ((N(CH₃)₄)IO₄), tetramethylammonium persulfate ((N(CH₃)₄)S₂O₈), tetrabutylammonium peroxomonosulfate, peroxomonosulfuric acid, urea hydrogen peroxide ((CO(NH₂)₂)H₂O₂), peracetic acid (CH₃(CO)OOH), t-butyl hydroperoxide, nitrobenzenesulfonate, 1,4-benzoquinone, toluquinone, dimethyl-1,4-benzoquinone, chloranil, alloxan, periodic acid, and combinations thereof.

In some embodiments, the pretreatment composition comprises 0.1% to 20%, or any range or subrange between 0.1% to 20%, by weight of the oxidant based on the total weight of the pretreatment composition. In some embodiments, the pretreatment composition comprises 0.1% to 19%, 0.1% to 18%, 0.1% to 17%, 0.1% to 16%, 0.1% to 15%, 0.1% to 14%, 0.1% to 13%, 0.1% to 12%, 0.1% to 11%, 0.1% to 10%, 0.1% to 9%, 0.1% to 8%, 0.1% to 7%, 0.1% to 6%, 0.1% to 5%, 0.1% to 4%, 0.1% to 3%, 0.1% to 2%, 0.1% to 1%, 0.1% to 0.9%, 0.1% to 0.8%, 0.1% to 0.7%, 0.1% to 0.6%, 0.1% to 0.5%, 0.1% to 0.4%, 0.1% to 0.3%, or 0.1% to 0.2% by weight of the oxidant based on the total weight of the pretreatment composition. In some embodiments, the pretreatment composition comprise 0.2% to 20%, 0.3% to 20%, 0.4% to 20%, 0.5% to 20%, 0.6% to 20%, 0.7% to 20%, 0.8% to 20%, 0.9% to 20%, 1% to 20%, 2% to 20%, 3% to 20%, 4% to 20%, 5% to 20%, 6% to 20%, 7% to 20%, 8% to 20%, 9% to 20%, 10% to 20%, 11% to 20%, 12% to 20%, 13% to 20%, 14% to 20%, 15% to 20%, 16% to 20%, 17% to 20%, 18% to 20%, or 19% to 20% by weight of the oxidant based on the total weight of the pretreatment composition.

In some embodiments, the pretreatment composition comprises a surfactant. In some embodiments, the surfactant comprises at least one of a cationic surfactant, an anionic surfactant, a zwitterionic surfactant, a nonionic surfactant, or any combination thereof.

Non limiting examples of nonionic surfactants include, but are not limited to, at least one of polyoxyethylene lauryl ether, dodecenylsuccinic acid monodiethanol amide, ethylenediamine tetrakis(ethoxylate-block-propoxylate) tetrol, polyethylene glycols, polypropylene glycols, polyethylene or polypropylene glycol ethers, block copolymers based on ethylene oxide and propylene oxide, polyoxypropylene sucrose ether, t-octylphenoxypolyethoxyethanol, 10-ethoxy-9,9-dimethyldecan-1-amine, Polyoxyethylene (9) nonylphenylether, branched, polyoxyethylene (40) nonylphenylether, branched, polyoxyethylene sorbitol hexaoleate, polyoxyethylene sorbitol tetraoleate, polyethylene glycol sorbitan monooleate, sorbitan monooleate, alcohol alkoxylates, alkyl-polyglucoside, ethyl perfluorobutyrate, siloxane modified polysilazane, silicone-polyether copolymers, ethoxylated fluorosurfactants, a C₁₂ branched diphenyloxide disulfonic acid, methanedisulfonic acid, ethanedisulfonic acid, 1,3-propanedisulfonic acid, or any combination thereof.

Non-limiting examples of cationic surfactants include, but are not limited to, at least one of cetyl trimethylammonium bromide (CTAB), heptadecanefluorooctane sulfonic acid, tetraethylammonium, stearyl trimethylammonium chloride, 4-(4-diethylaminophenylazo)-1-(4-nitrobenzyl)pyridium bromide, cetylpyridinium chloride monohydrate, benzalkonium chloride, benzethonium chloride benzyldimethyldodecylammonium chloride, benzyldimethylhexadecylammonium chloride, hexadecyltrimethylammonium bromide, dimethyldioctadecylammonium chloride, dodecyltrimethylammonium chloride, hexadecyltrimethylammonium p-toluenesulfonate, didodecyldimethylammonium bromide, di(hydrogenated tallow)dimethylammonium chloride, tetraheptylammonium bromide, tetrakis(decyl)ammonium bromide, oxyphenonium bromide, guanidine hydrochloride (C(NH2)3Cl), tetrabutylammonium trifluoromethanesulfonate, dimethyldioctadecylammonium chloride, dimethyldihexadecylammonium bromide, di(hydrogenated tallow)dimethylammonium chloride, polyalkyleneimine, polyethyleneimine, or any combination thereof.

Non-limiting examples of anionic surfactants include, but are not limited to, at least one of ammonium polyacrylate, modified polyacrylic acid in water, phosphate polyether ester, decylphosphonic acid, dodecylphosphonic acid (DDPA), tetradecylphosphonic acid, hexadecylphosphonic acid, octadecylphosphonic acid, dodecylbenzenesulfonic acid, poly(acrylic acid sodium salt), sodium polyoxyethylene lauryl ether, sodium dihexylsulfosuccinate, dicyclohexyl sulfosuccinate sodium salt, sodium 7-ethyl-2-methyl-4-undecyl sulfate, phosphate fluorosurfactants, or any combination thereof.

Non-limiting examples of zwitterionic surfactants include, but are not limited to, at least one of acetylenic diols or modified acetylenic diols, cocamido propyl betaine, ethylene oxide alkylamines, N, N-dimethyldodecylamine N-oxide, sodium cocaminpropinate, 3-(N,N-dimethylmyristylammonio) propanesulfonate, (3-(4-heptyl)phenyl-3-hydroxypropyl)dimethylammoniopropanesulfonate, or any combination thereof.

In some embodiments, the pretreatment composition comprises 0.1% to 10%, or range or subrange between 0.1% to 10%, by weight of the surfactant based on the total weight of the pretreatment composition. In some embodiments, the pretreatment composition comprises 0.1% to 9%, 0.1% to 8%, 0.1% to 7%, 0.1% to 6%, 0.1% to 5%, 0.1% to 4%, 0.1% to 3%, 0.1% to 2%, 0.1% to 1%, 0.1% to 0.9%, 0.1% to 0.8%, 0.1% to 0.7%, 0.1% to 0.6%, 0.1% to 0.5%, 0.1% to 0.4%, 0.1% to 0.3%, 0.1% to 0.2%, 0.2% to 10%, 0.3% to 10%, 0.4% to 10%, 0.5% to 10%, 0.6% to 10%, 0.7% to 10%, 0.8% to 10%, 0.9% to 10%, 1% to 10%, 2% to 10%, 3% to 10%, 4% to 10%, 5% to 10%, 6% to 10%, 7% to 10%, 8% to 10%, or 9% to 10% by weight of the surfactant based on the total weight of the pretreatment composition.

In some embodiments, when a substrate comprising a silicon component and a silicon germanium component is contacted with the pretreatment composition and subsequently contacted with an etchant composition, the etchant composition exhibits a selectivity of the silicon germanium component to the silicon component of at least 30. In some embodiments, when a substrate comprising a silicon component and a silicon germanium component is contacted with the pretreatment composition and subsequently contacted with an etchant composition, the etchant composition exhibits a selectivity of the silicon germanium component to the silicon component of at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, or at least 300.

In some embodiments, when a substrate comprising a silicon component and a silicon germanium component is contacted with the pretreatment composition and subsequently contacted with an etchant composition, the etchant composition exhibits a selectivity of the silicon germanium component to the silicon component of 30 to 300, or any range or subrange between 30 to 300. In some embodiments, when a substrate comprising a silicon component and a silicon germanium component is contacted with the pretreatment composition and subsequently contacted with an etchant composition, the etchant composition exhibits a selectivity of the silicon germanium component to the silicon component of 30 to 290, 30 to 280, 30 to 270, 30 to 260, 30 to 270, 30 to 260, 30 to 250, 30 to 240, 30 to 230, 30 to 220, 30 to 210, 30 to 200, 30 to 190, 30 to 180, 30 to 170, 30 to 160, 30 to 150, 30 to 140, 30 to 130, 30 to 120, 30 to 110, 30 to 100, 30 to 95, 30 to 90, 30 to 85, 30 to 80, 30 to 75, 30 to 70, 30 to 65, 30 to 60, 30 to 55, 30 to 50, 30 to 45, 30 to 40, or 30 to 35.

In some embodiments, when a substrate comprising a silicon component and a silicon germanium component is contacted with the pretreatment composition and subsequently contacted with an etchant composition, the etchant composition exhibits a selectivity of the silicon germanium component to the silicon component of 40 to 300, 50 to 300, 60 to 300, 70 to 300, 80 to 300, 90 to 300, 100 to 300, 110 to 300, 120 to 300, 130 to 300, 140 to 300, 150 to 300, 160 to 300, 170 to 300, 180 to 300, 190 to 300, 200 to 300, 210 to 300, 220 to 300, 230 to 300, 240 to 300, 250 to 300, 260 to 300, 270 to 300, 280 to 300, or 290 to 300.

In some embodiments, the contacting with the pretreatment composition may comprise applying the pretreatment composition to the substrate by at least one of spraying the pretreatment composition onto the substrate; dipping (in a static or dynamic volume of pretreatment composition) the substrate into the pretreatment composition; contacting the substrate with another material (e.g., a pad, or fibrous sorbent applicator element, that has the pretreatment composition absorbed thereon); contacting the substrate with an amount of the pretreatment composition in a circulating pool; submersing the substrate in the pretreatment composition; or any combination thereof, among other techniques in which the pretreatment composition is brought into contact with the substrate. The application may be in a batch or single wafer apparatus.

In some embodiments, the contacting with an etchant composition may comprise applying the etchant composition to the substrate by at least one of spraying the etchant composition onto the substrate; dipping (in a static or dynamic volume of pretreatment composition) the substrate into the etchant composition; contacting the substrate with another material (e.g., a pad, or fibrous sorbent applicator element, that has the etchant composition absorbed thereon); contacting the substrate with an amount of the etchant composition in a circulating pool; submersing the substrate in the etchant composition; or any combination thereof, among other techniques in which the etchant composition is brought into contact with the substrate. The application may be in a batch or single wafer apparatus.

Some embodiments relate to a kit for selectively etching silicon germanium. In some embodiments, the kit comprises a pretreatment composition. In some embodiments, the pretreatment composition of any one or more of the pretreatment compositions disclosed herein.

In some embodiments, the pretreatment composition is configured to cover a silicon component of a substrate. In some embodiments, the pretreatment composition is configured to react with the silicon component of a substrate to form a silicon oxide layer. In some embodiments, the pretreatment composition is configured to cover a silicon component of a substrate to protect the silicon component from an etchant composition. In some embodiments, the substrate comprises a silicon component and a silicon germanium component. In some embodiments, the pretreatment composition is configured to cover the silicon component of the substrate but not cover the silicon germanium component.

In some embodiments, the kit comprises an etchant composition. The etchant compositions may comprise a solution. In some embodiments, the etchant composition comprises a liquid solution. In some embodiments, the etchant composition comprises a liquid solution and at least one solid component. In some embodiments, the etchant composition comprises a slurry. In some embodiments, the etchant composition comprises a suspension. In some embodiments, the etchant composition comprises an emulsion. In some embodiments, the etchant composition comprises a solution of at least one dissolved component. In some embodiments, the etchant composition comprises any combination of the foregoing.

In some embodiments, the etchant composition is configured to etch a silicon germanium component of the substrate.

In some embodiments, the etchant composition has a pH of 3 or less. In some embodiments, the etchant composition has a pH of 2 or less or 1 or less. In some embodiments, the etchant composition has a pH of 0 to 3, or any range or subrange between 0 to 3. In some embodiments, the etchant composition has a pH of 0 to 2.5, 0 to 2, 0 to 1.5, 0 to 1, 0 to 0.5, 0.5 to 3, 1 to 3, 1.5 to 3, 2 to 3, or 2.5 to 3.

The etchant composition may comprise a halide compound. Non-limiting examples of the halide compound include, for example and without limitation, at least one of hydrogen fluoride (HF), hexafluorosilicic acid (H₂SiF₆), ammonium fluoride (NH₄F), ammonium bifluoride (NH₄F₂), hydrogen chloride (HCl), hydrogen bromide (HBr), tetrafluoroboric acid, hexafluorosilicic acid, a compound comprising a boron-fluoride bond, a compound comprising a silicon-fluoride bond, tetrabutylammonium tetrafluoroborate (TBA-BF₄), tetraalkylammonium fluorides, or any combination thereof. In some embodiments, the halide compound comprises hydrogen fluoride (HF). In some embodiments, the halide compound comprises hexafluorosilicic acid (H₂SiF₆). In some embodiments, the halide compound comprises ammonium fluoride (NH₄F). In some embodiments, the halide compound comprises ammonium bifluoride (NH₄F₂). In some embodiments, the halide compound comprises hydrogen chloride (HCl). In some embodiments, the halide compound comprises hydrogen bromide (HBr).

The etchant composition may comprise 1% to 10%, or any range or subrange between 1% and 10%, by weight of the halide compound based on the total weight of the etchant composition. In some embodiments, the etchant composition comprises 1% to 9.5%, 1% to 9%, 1% to 8.5%, 1% to 8%, 1% to 7.5%, 1% to 7%, 1% to 6.5%, 1% to 6%, 1% to 5.5%, 1% to 5%, 1% to 4.5%, 1% to 4%, 1% to 3.5%, 1% to 3%, 1% to 2.5%, 1% to 2%, or 1% to 1.5% by weight of the halide compound based on the total weight of the etchant composition. In some embodiments, the etchant composition comprises 1.5% to 10%, 2% to 10%, 2.5% to 10%, 3% to 10%, 3.5% to 10%, 4% to 10%, 4.5% to 10%, 5% to 10%, 5.5% to 10%, 6% to 10%, 6.5% to 10%, 7% to 10%, 7.5% to 10%, 8% to 10%, 8.5% to 10%, 9% to 10%, or 9.5% to 10% by weight of the halide compound based on the total weight of the etchant composition. In some embodiments, the weight percentage is based on a total weight of the formulation.

The etchant composition may comprise an oxidizing agent. Non-limiting examples of the oxidizing agent include, for example and without limitation, at least one of acetic acid (CH₃COOH), hydrogen peroxide (H₂O₂), formic acid (CH₂O₂), peracetic acid (CH₃CO₃H), performic acid (CH₂O₃), sulfuric acid (H₂SO₄), or any combination thereof. In some embodiments, the oxidizing agent comprises acetic acid (CH₃COOH). In some embodiments, the oxidizing agent comprises hydrogen peroxide (H₂O₂). In some embodiments, the oxidizing agent comprises formic acid (CH₂O₂). In some embodiments, the oxidizing agent comprises peracetic acid (CH₃CO₃H). In some embodiments, the oxidizing agent comprises performic acid (CH₂O₃). In some embodiments, the oxidizing agent comprises sulfuric acid (H₂SO₄).

The etchant composition may comprise 20% to 80%, or any range or subrange between 20% and 80%, by weight of the oxidizing agent based on the total weight of the etchant composition. In some embodiments, the etchant composition comprises comprise 20% to 75%, 20% to 70%, 20% to 65%, 20% to 60%, 20% to 55%, 20% to 50%, 20% to 45%, 20% to 40%, 20% to 35%, 20% to 30%, or 20% to 25% by weight of the oxidizing agent based on the total weight of the etchant composition. In some embodiments, the etchant composition comprises 25% to 80%, 30% to 80%, 35% to 80%, 40% to 80%, 45% to 80%, 50% to 80%, 55% to 80%, 60% to 80%, 65% to 80%, 70% to 80%, or 75% to 80% by weight of the oxidizing agent based on the total weight of the etchant composition. In some embodiments, the weight percentage is based on a total weight of the formulation.

The etchant composition may comprise an inhibitor. Non-limiting examples of the inhibitor include, for example and without limitation, at least one of a polyethylenimine (PEI), a polyethylene, a polyvinylpyrrolidone, a silicic acid, a polyethylene glycol, or any combination thereof. In some embodiments, the inhibitor comprises a polyethylenimine. In some embodiments, the inhibitor comprises a polyethylene. In some embodiments, the inhibitor comprises a polyvinylpyrrolidone. In some embodiments, the inhibitor comprises a silicic acid. In some embodiments, the inhibitor comprises a polyethylene glycol.

The etchant composition may comprise 0.01% to 10%, or any range or subrange between 0.01% and 10%, by weight of the inhibitor based on the total weight of the etchant composition. In some embodiments, the etchant composition comprises 0.001% to 9.5%, 0.01% to 9%, 0.01% to 8.5%, 0.01% to 8%, 0.01% to 7.5%, 0.01% to 7%, 0.01% to 6.5%, 0.01% to 6%, 0.01% to 5.5%, 0.01% to 5%, 0.01% to 4.5%, 0.01% to 4%, 0.01% to 3.5%, 0.01% to 3%, 0.01% to 2.5%, 0.01% to 2%, 0.01% to 1.5%, 0.01% to 1%, 0.01% to 0.8%, 0.01% to 0.6%, 0.01% to 0.5%, 0.01% to 0.4%, 0.01% to 0.2%, 0.01% to 0.1%, 0.01% to 0.08%, 0.01% to 0.06%, 0.01% to 0.05%, 0.01% to 0.04%, or 0.01% to 0.02% by weight of the inhibitor based on the total weight of the etchant composition. In some embodiments, the etchant composition comprises 0.1% to 10%, 1% to 10%, 1.5% to 10%, 2% to 10%, 2.5% to 10%, 3% to 10%, 3.5% to 10%, 4% to 10%, 4.5% to 10%, 5% to 10%, 5.5% to 10%, 6% to 10%, 6.5% to 10%, 7% to 10%, 7.5% to 10%, 8% to 10%, 8.5% to 10%, 9% to 10%, or 9.5% to 10% by weight of the inhibitor based on the total weight of the etchant composition. In some embodiments, the weight percentage is based on a total weight of the formulation.

In some embodiments, the etchant composition comprises 0.1% to 1.5%, or any range or subrange between 0.1% and 1.5%, by weight of the inhibitor based on the total weight of the etchant composition. In some embodiments, the etchant composition comprises 0.1% to 1.4%, 0.1% to 1.3%, 0.1% to 1.2%, 0.1% to 1.1%, 0.1% to 1%, 0.1% to 0.9%, 0.1% to 0.8%, 0.1% to 0.7%, 0.1% to 0.6%, 0.1% to 0.5%, 0.1% to 0.4%, 0.1% to 0.3%, or 0.1% to 0.2% by weight of the inhibitor based on the total weight of the etchant composition. In some embodiments, the etchant composition comprises 0.2% to 1.5%, 0.3% to 1.5%, 0.4% to 1.5%, 0.5% to 1.5%, 0.6% to 1.5%, 0.7% to 1.5%, 0.8% to 1.5%, 0.9% to 1.5%, 1% to 1.5%, 1.1% to 1.5%, 1.2% to 1.5%, 1.3% to 1.5%, or 1.4% to 1.5% by weight of the inhibitor based on the total weight of the etchant composition. In some embodiments, the weight percentage is based on a total weight of the formulation.

The etchant composition may comprise an organic solvent. In some embodiments, the organic solvent comprises at least one of methanol, ethanol, isopropanol, butanol, pentanol, hexanol, 2-ethyl-1-hexanol, heptanol, octanol, ethylene glycol, propylene glycol, butylene glycol, butylene carbonate, ethylene carbonate, propylene carbonate, dipropylene glycol, diethylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether (DPGME), tripropylene glycol methyl ether (TPGME), dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, 2,3-dihydrodecafluoropentane, ethyl perfluorobutylether, methyl perfluorobutylether, dimethyl sulfoxide (DMSO), sulfolane, 4-methyl-2-pentanol, diethylene glycol diethyl ether, diethylene glycol ethyl methyl ether, 3-methyl-2-oxazolidone, N-methylmorpholine N-oxide, trimethylamine N-oxide, benzene, or combinations thereof.

In some embodiments, the etchant composition comprises 0.1% to 20%, or any range or subrange between 0.1% to 20%, by weight of the organic solvent based on the total weight of the etchant composition. In some embodiments, the etchant composition comprises 0.1% to 19%, 0.1% to 18%, 0.1% to 17%, 0.1% to 16%, 0.1% to 15%, 0.1% to 14%, 0.1% to 13%, 0.1% to 12%, 0.1% to 11%, 0.1% to 10%, 0.1% to 9%, 0.1% to 8%, 0.1% to 7%, 0.1% to 6%, 0.1% to 5%, 0.1% to 4%, 0.1% to 3%, 0.1% to 2%, 0.1% to 1%, 0.1% to 0.9%, 0.1% to 0.8%, 0.1% to 0.7%, 0.1% to 0.6%, 0.1% to 0.5%, 0.1% to 0.4%, 0.1% to 0.3%, or 0.1% to 0.2% by weight of the organic solvent based on the total weight of the etchant composition. In some embodiments, the etchant composition comprise 0.2% to 20%, 0.3% to 20%, 0.4% to 20%, 0.5% to 20%, 0.6% to 20%, 0.7% to 20%, 0.8% to 20%, 0.9% to 20%, 1% to 20%, 2% to 20%, 3% to 20%, 4% to 20%, 5% to 20%, 6% to 20%, 7% to 20%, 8% to 20%, 9% to 20%, 10% to 20%, 11% to 20%, 12% to 20%, 13% to 20%, 14% to 20%, 15% to 20%, 16% to 20%, 17% to 20%, 18% to 20%, or 19% to 20% by weight of the organic solvent based on the total weight of the etchant composition.

The etchant composition may comprise water or any derivative thereof. The etchant composition may comprise at least 5% by weight of water based on the total weight of the etchant composition. For example, in some embodiments, the etchant composition comprises at least 1%, at least 3%, at least 5%, at least 10%, at least 15%, at least 20%, at least 25%, at least 30%, at least 35%, at least 40%, at least 40% by weight of water based on the total weight of the etchant composition. In some embodiments, the etchant composition comprises no greater than 50% by weight of water based on the total weight of the etchant composition. For example, in some embodiments, the etchant composition comprises no greater than 45%, no greater than 40%, no greater than 35%, no greater than 30%, no greater than 25%, no greater than 20%, no greater than 15%, no greater than 10%, or no greater than 5% by weight of water based on the total weight of the etchant composition.

The etchant composition may comprise 1% to 50% by weight of the water based on the total weight of the etchant composition, or any range or subrange between 1% to 50%. For example, in some embodiments, the etchant composition comprises 1% to 45%, 1% to 40%, 1% to 35%, 1% to 30%, 1% to 25%, 1% to 20%, 1% to 15%, 1% to 10%, 1% to 5%, 5% to 45%, 5% to 40%, 5% to 35%, 5% to 30%, 5% to 25%, 5% to 20%, 5% to 15%, 5% to 10%, 10% to 50%, 15% to 50%, 20% to 50%, 25% to 50%, 30% to 50%, 35% to 50%, 40% to 50%, 45% to 50%, 5% to 25%, 6% to 25%, 8% to 25%, 10% to 25%, 12% to 25%, 14% to 25%, 15% to 25%, 16% to 25%, 18% to 25%, 20% to 25%, 22% to 25%, 24% to 25%, 5% to 24%, 5% to 22%, 5% to 18% 5% to 16%, 5% to 14%, 5% to 12%, 5% to 10%, 5% to 8%, or 5% to 6% by weight of the water based on a total weight of the etchant composition.

In some embodiments, the etchant composition comprises a surfactant. In some embodiments, the surfactant may comprise any one or more of the surfactant disclosed herein.

In some embodiments, the etchant composition comprises 0.1% to 10%, or range or subrange between 0.1% to 10%, by weight of the surfactant based on the total weight of the etchant composition. In some embodiments, the etchant composition comprises 0.1% to 9%, 0.1% to 8%, 0.1% to 7%, 0.1% to 6%, 0.1% to 5%, 0.1% to 4%, 0.1% to 3%, 0.1% to 2%, 0.1% to 1%, 0.1% to 0.9%, 0.1% to 0.8%, 0.1% to 0.7%, 0.1% to 0.6%, 0.1% to 0.5%, 0.1% to 0.4%, 0.1% to 0.3%, 0.1% to 0.2%, 0.2% to 10%, 0.3% to 10%, 0.4% to 10%, 0.5% to 10%, 0.6% to 10%, 0.7% to 10%, 0.8% to 10%, 0.9% to 10%, 1% to 10%, 2% to 10%, 3% to 10%, 4% to 10%, 5% to 10%, 6% to 10%, 7% to 10%, 8% to 10%, or 9% to 10% by weight of the surfactant based on the total weight of the etchant composition.

In some embodiments, when a substrate comprising a silicon component and a silicon germanium component is contacted with the pretreatment composition and subsequently contacted with the etchant composition, the etchant composition exhibits a selectivity of the silicon germanium component to the silicon component of at least 30. In some embodiments, when a substrate comprising a silicon component and a silicon germanium component is contacted with the pretreatment composition and subsequently contacted with the etchant composition, the etchant composition exhibits a selectivity of the silicon germanium component to the silicon component of at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, or at least 300.

In some embodiments, when a substrate comprising a silicon component and a silicon germanium component is contacted with the pretreatment composition and subsequently contacted with the etchant composition, the etchant composition exhibits a selectivity of the silicon germanium component to the silicon component of 30 to 300, or any range or subrange between 30 to 300. In some embodiments, when a substrate comprising a silicon component and a silicon germanium component is contacted with the pretreatment composition and subsequently contacted with the etchant composition, the etchant composition exhibits a selectivity of the silicon germanium component to the silicon component of 30 to 290, 30 to 280, 30 to 270, 30 to 260, 30 to 270, 30 to 260, 30 to 250, 30 to 240, 30 to 230, 30 to 220, 30 to 210, 30 to 200, 30 to 190, 30 to 180, 30 to 170, 30 to 160, 30 to 150, 30 to 140, 30 to 130, 30 to 120, 30 to 110, 30 to 100, 30 to 95, 30 to 90, 30 to 85, 30 to 80, 30 to 75, 30 to 70, 30 to 65, 30 to 60, 30 to 55, 30 to 50, 30 to 45, 30 to 40, or 30 to 35.

In some embodiments, when a substrate comprising a silicon component and a silicon germanium component is contacted with the pretreatment composition and subsequently contacted with the etchant composition, the etchant composition exhibits a selectivity of the silicon germanium component to the silicon component of 40 to 300, 50 to 300, 60 to 300, 70 to 300, 80 to 300, 90 to 300, 100 to 300, 110 to 300, 120 to 300, 130 to 300, 140 to 300, 150 to 300, 160 to 300, 170 to 300, 180 to 300, 190 to 300, 200 to 300, 210 to 300, 220 to 300, 230 to 300, 240 to 300, 250 to 300, 260 to 300, 270 to 300, 280 to 300, or 290 to 300.

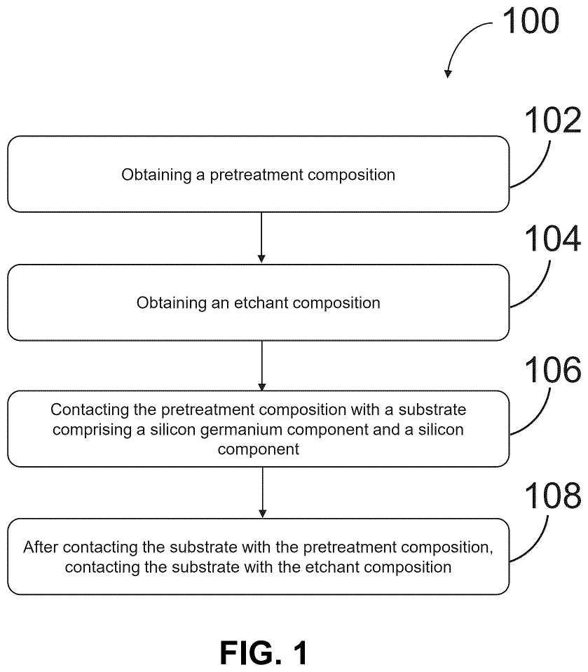

FIG. 1 is a flowchart of a method for selectively etching silicon germanium 100, according to some embodiments. As shown in FIG. 1, the method for selectively etching silicon germanium 100 may comprise one or more of the following steps: obtaining 102 a pretreatment composition, obtaining 104 an etchant composition, contacting 106 the pretreatment composition with a substrate comprising a silicon germanium component and a silicon component; and after contacting 106 the substrate with the pretreatment composition, contacting 108 the substrate with the etchant composition.

At step 102, in some embodiments, the method comprises obtaining a pretreatment composition. Any of the pretreatment composition disclosed herein may be used. For example, in some embodiments, the pretreatment composition comprises at least one of a water, an acid component, an inhibitor, 1% to 20% by weight of a silane coupling agent based on a total weight of the pretreatment composition, or any combination thereof. It will be appreciated that other pretreatment compositions disclosed herein may be used without departing from this disclosure.

At step 104, in some embodiments, the method comprises obtaining an etchant composition. The etchant composition can comprise any one or more of the etchant compositions disclosed herein. For example, in some embodiments, the etchant composition comprises at least one of a water, a halide component, an oxidizing agent, an inhibitor, an organic solvent, a surfactant, or any combination thereof. It will be appreciated that other etchant compositions disclosed herein may be used without departing from this disclosure.

At step 106, in some embodiments, the method comprises contacting the pretreatment composition with a substrate comprises a silicon germanium component and a silicon component. In some embodiments, the contacting may comprise applying the pretreatment composition to the substrate by at least one of spraying the pretreatment composition onto the substrate; dipping (in a static or dynamic volume of pretreatment composition) the substrate into the pretreatment composition; contacting the substrate with another material (e.g., a pad, or fibrous sorbent applicator element, that has the pretreatment composition absorbed thereon); contacting the substrate with an amount of the pretreatment composition in a circulating pool; submersing the substrate in the pretreatment composition; or any combination thereof, among other techniques in which the pretreatment composition is brought into contact with the substrate. The application may be in a batch or single wafer apparatus.

In some embodiments, the substrate comprises a silicon germanium component and a silicon component. In some embodiments, the substrate comprises layers of silicon germanium alternating with layers of silicon. In some embodiments, the substrate comprises a silicon germanium portion and a silicon portion.

At step 108, in some embodiments, the method comprises, after contacting the substrate with the pretreatment composition, contacting the substrate with the etchant composition. In some embodiments, the contacting may comprise applying the etchant composition to the substrate by at least one of spraying the etchant composition onto the substrate; dipping (in a static or dynamic volume of pretreatment composition) the substrate into the etchant composition; contacting the substrate with another material (e.g., a pad, or fibrous sorbent applicator element, that has the etchant composition absorbed thereon); contacting the substrate with an amount of the etchant composition in a circulating pool; submersing the substrate in the etchant composition; or any combination thereof, among other techniques in which the etchant composition is brought into contact with the substrate. The application may be in a batch or single wafer apparatus.

In some embodiments, the etchant composition exhibits a selectivity of the silicon germanium component to the silicon component of at least 30. In some embodiments, the etchant composition exhibits a selectivity of the silicon germanium component to the silicon component of at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, or at least 300.

In some embodiments, the etchant composition exhibits a selectivity of the silicon germanium component to the silicon component of 30 to 300, or any range between 30 to 300. In some embodiments, the etchant composition exhibits a selectively of the silicon germanium component to the silicon component of 30 to 290, 30 to 280, 30 to 270, 30 to 260, 30 to 270, 30 to 260, 30 to 250, 30 to 240, 30 to 230, 30 to 220, 30 to 210, 30 to 200, 30 to 190, 30 to 180, 30 to 170, 30 to 160, 30 to 150, 30 to 140, 30 to 130, 30 to 120, 30 to 110, 30 to 100, 30 to 95, 30 to 90, 30 to 85, 30 to 80, 30 to 75, 30 to 70, 30 to 65, 30 to 60, 30 to 55, 30 to 50, 30 to 45, 30 to 40, or 30 to 35.

In some embodiments, the etchant composition exhibits a selectivity of the silicon germanium component to the silicon component of 40 to 300, 50 to 300, 60 to 300, 70 to 300, 80 to 300, 90 to 300, 100 to 300, 110 to 300, 120 to 300, 130 to 300, 140 to 300, 150 to 300, 160 to 300, 170 to 300, 180 to 300, 190 to 300, 200 to 300, 210 to 300, 220 to 300, 230 to 300, 240 to 300, 250 to 300, 260 to 300, 270 to 300, 280 to 300, or 290 to 300. In some embodiments, the etchant composition exhibits a selectivity of the silicon germanium component to the silicon component of up to 1000.

Any one or more of the embodiments disclosed herein shall be understood to be combinable without departing from the scope or spirit of the disclosure.

### Example 1

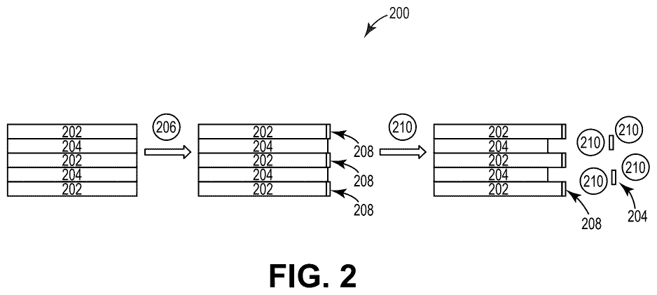

FIG. 2. Is a schematic diagram of the method for selectively etching silicon germanium 200, according to Example 1. A substrate comprising a silicon component 202 and a silicon germanium component 204 is obtained. A pretreatment composition 206 is obtained. The pretreatment composition comprises a water, an acid component, an inhibitor, and 1% to 20% of a silane coupling agent based on a total weight of the pretreatment composition. The pretreatment composition 206 is contacted with the substrate and covers 208 the silicon component 202. An etchant composition 210 is obtained. The etchant composition 210 comprises a water, a halide component, an oxidizing agent, an inhibitor, an organic solvent, and a surfactant. The substrate is contacted with the etchant composition 210. The etchant composition 210 selectively etches the silicon germanium component 204. The etchant composition 210 exhibits a selectivity of the silicon germanium component 204 to the silicon component 202 of 30 to 300.

### Example 2

A pretreatment composition comprising 89% to 97% by weight of a deionized water based on the total weight of the pretreatment composition, an inhibitor (polyethyleneimine), a surfactant (polyethylene glycol), 0.5% by weight of a phosphoric acid based on the total weight of the pretreatment composition, and 2% to 10% by weight of a methyltrimethoxysilane (MTMS) coupling agent based on the total weight of the pretreatment composition was obtained. The pretreatment composition was contacted with a substrate comprising a silicon component and a silicon germanium component for 10 minutes. The amount of MTMS present in the pretreatment composition was varied as indicated in Tables 1 and 2. The substrate was subsequently contacted with either Etchant Composition 1 (EC 1) or Etchant Composition 2 (EC 2) and the etch rates (ER) were evaluated. The etchant compositions were also contacted with the substrate without the pretreatment and the etch rates were evaluated. Etchant Composition 1 (EC 1) comprised deionized water, acetic acid, formic acid, sulfuric acid, hydrogen fluoride, a diphenyl oxide disulfonic acid, a polyethylene glycol, and silicic acid. The results using Etchant Composition 1 (EC 1) are shown in Table 1. Etchant Composition 2 comprised deionized water, acetic acid, formic acid, sulfuric acid, an ammonium fluoride, fluorosilicic acid, a diphenyl oxide disulfonic acid, a polyethylene glycol, and silicic acid. The results using Etchant Composition 2 (EC 2) are shown in Table 2.

TABLE 1

| | Si ER | SiGe ER | SiGe/Si |
|---|---|---|---|
| Formulation | (nm/min) | (nm/min) | selectivity |
| EC 1 | 0.07 | 8.57 | 122 |
| 10% MTMS + EC 1 | 0.05 | 6.94 | 142 |
| 5% MTMS + EC 1 | 0.04 | 6.35 | 163 |
| 2% MTMS + EC 1 | 0.03 | 7.13 | 223 |

TABLE 2

| | Si ER | SiGe ER | SiGe/Si |
|---|---|---|---|
| Formulation | (nm/min) | (nm/min) | selectivity |
| EC 2 | 0.04 | 4.22 | 100 |
| 10% MTMS + EC 2 | 0.04 | 4.01 | 105 |
| 5% MTMS + EC 2 | 0.04 | 4.65 | 133 |
| 2% MTMS + EC 2 | 0.03 | 3.94 | 127 |

As shown in Tables 1 and 2, the pretreatment composition increases the subsequent etchant composition's selectivity of the silicon germanium component in comparison to the silicon component.

### Example 3

The pretreatment composition from Example 2 with 10% of the methyltrimethoxysilane coupling agent was used to pretreat a substrate comprising a silicon germanium component and a silicon component. The amount of time the pretreatment composition was contacted with the substrate was varied between 10 minutes and 15 minutes. After the pretreatment, the substrate was subsequently contacted with Etchant Composition 1 (EC 1) from Example 2 and the etch rate (ER) was evaluated. The results are shown in Table 3.

TABLE 3

| | | | | SiGe/Si |
|---|---|---|---|---|
| | Time contacted | Si ER | SiGe ER | selec- |
| Formulation | with pretreatment | (nm/min) | (nm/min) | tivity |
| 10% MTMS + EC 1 | 10 minutes | 0.04 | 6.35 | 163 |
| 10% MTMS + EC 1 | 15 minutes | 0.03 | 6.44 | 208 |

As shown in Table 3, contacting the substrate with the pretreatment composition for a longer period of time results in the subsequent etchant composition having a higher selectivity to the silicon germanium component as compared to the silicon component.

### Example 4

A pretreatment composition comprising 89% to 97% by weight of a deionized water based on the total weight of the pretreatment composition, an inhibitor (polyethyleneimine), a surfactant (polyethylene glycol), 0.5% by weight of a phosphoric acid based on the total weight of the pretreatment composition, and 2% to 10% by weight of a dimethyltetramethoxydisiloxane coupling agent based on the total weight of the pretreatment composition is obtained. The pretreatment composition is contacted with a substrate comprising a silicon component and a silicon germanium component for 10 minutes. The substrate is subsequently contacted with either Etchant Composition 1 or Etchant Composition 2 and the etch rates are evaluated. The etchant compositions are also contacted with the substrate without the pretreatment and the etch rates are evaluated. Etchant Composition 1 comprises deionized water, acetic acid, formic acid, sulfuric acid, hydrogen fluoride, a diphenyl oxide disulfonic acid, a polyethylene glycol, and silicic acid. Etchant Composition 2 comprises deionized water, acetic acid, formic acid, sulfuric acid, an ammonium fluoride, fluorosilicic acid, a diphenyl oxide disulfonic acid, a polyethylene glycol, and silicic acid.

Similarly to Example 2, the pretreatment composition increases the subsequent etchant composition's selectivity of the silicon germanium component in comparison to the silicon component.

### Example 5

A pretreatment composition comprising 89% to 97% by weight of a deionized water based on the total weight of the pretreatment composition, an inhibitor (polyethyleneimine), a surfactant (polyethylene glycol), 0.5% by weight of a phosphoric acid based on the total weight of the pretreatment composition, and 2% to 10% by weight of a (3-aminopropyl)triethoxysilane coupling agent based on the total weight of the pretreatment composition is obtained. The pretreatment composition is contacted with a substrate comprising a silicon component and a silicon germanium component for 10 minutes. The substrate is subsequently contacted with either Etchant Composition 1 or Etchant Composition 2 and the etch rates are evaluated. The etchant compositions are also contacted with the substrate without the pretreatment and the etch rates are evaluated. Etchant Composition 1 comprises deionized water, acetic acid, formic acid, sulfuric acid, hydrogen fluoride, a diphenyl oxide disulfonic acid, a polyethylene glycol, and silicic acid. Etchant Composition 2 comprises deionized water, acetic acid, formic acid, sulfuric acid, an ammonium fluoride, fluorosilicic acid, a diphenyl oxide disulfonic acid, a polyethylene glycol, and silicic acid.

Similarly to Example 2, the pretreatment composition increases the subsequent etchant composition's selectivity of the silicon germanium component in comparison to the silicon component.

### Example 6

A pretreatment composition comprising 89% to 97% by weight of a deionized water based on the total weight of the pretreatment composition, an inhibitor (polyethyleneimine), a surfactant (polyethylene glycol), 0.5% by weight of a phosphoric acid based on the total weight of the pretreatment composition, and 2% to 10% by weight of a silane coupling agent of the formula: HO(O)C—Si(OH)₂—O—Si(OH)₂—C(O)OH based on the total weight of the pretreatment composition is obtained. The pretreatment composition is contacted with a substrate comprising a silicon component and a silicon germanium component for 10 minutes. The substrate is subsequently contacted with either Etchant Composition 1 or Etchant Composition 2 and the etch rates are evaluated. The etchant compositions are also contacted with the substrate without the pretreatment and the etch rates are evaluated. Etchant Composition 1 comprises deionized water, acetic acid, formic acid, sulfuric acid, hydrogen fluoride, a diphenyl oxide disulfonic acid, a polyethylene glycol, and silicic acid. Etchant Composition 2 comprises deionized water, acetic acid, formic acid, sulfuric acid, an ammonium fluoride, fluorosilicic acid, a diphenyl oxide disulfonic acid, a polyethylene glycol, and silicic acid.

Similarly to Example 2, the pretreatment composition increases the subsequent etchant composition's selectivity of the silicon germanium component in comparison to the silicon component.

### ASPECTS

Various Aspects are described below. It is to be understood that any one or more of the features recited in the following Aspect(s) can be combined with any one or more other Aspect(s).
Aspect 1. A pretreatment composition comprising:
   a water;
   an acid component;
   an inhibitor; and
   1% to 20% by weight of a silane coupling agent based on a total weight of the pretreatment composition;
   wherein, when a substrate comprising a silicon component and a silicon germanium component is contacted with the pretreatment composition and subsequently contacted with an etchant composition, the etchant composition exhibits a selectivity of the silicon germanium component to the silicon component of at least 30.
Aspect 2. The pretreatment composition according to Aspect 1, wherein the pretreatment composition has a pH of 4 to 7.
Aspect 3. The pretreatment composition according to any one of Aspects 1-2, wherein the pretreatment composition comprises 0.1% to 10% by weight of the acid component based on the total weight of the pretreatment composition.
Aspect 4. The pretreatment composition according to any one of Aspects 1-3, wherein the pretreatment composition comprises at least 60% by weight of the water based on a total weight of the pretreatment composition.
Aspect 5. The pretreatment composition according to any one of Aspects 1-4, wherein the pretreatment composition comprises 1% to 10% by weight of the silane coupling agent based on the total weight of the pretreatment composition.
Aspect 6. The pretreatment composition according to any one of Aspects 1-5, wherein the inhibitor comprises at least one of a nitride inhibitor, an oxide inhibitor, or any combination thereof.
Aspect 7. The pretreatment composition according to any one of Aspects 1-6, wherein in the inhibitor comprises at least one of a polyethylenimine, a polyethylene, a polyvinylpyrrolidone, a silicic acid, a polyethylene glycol, a polypropylene glycol, a quaternary ammonium compound, a benzotriazole, a pyridine, a pyrazole, or any combination thereof.
Aspect 8. The pretreatment composition according to any one of Aspects 1-7, wherein the silane coupling agent comprises at least one of methyltrimethoxysilane (MTMS), a 1,3-dimethyltetramethoxydisiloxane (MTMS dimer), a (3-aminopropyl)triethoxysilane, a mercaptomethyltrimethoxysilyl, a 7-octenyltrimethoxysilane, or any combination thereof.
Aspect 9. The pretreatment composition according to any one of Aspects 1-8, wherein, when a substrate comprising a silicon component and a silicon germanium component is contacted with the pretreatment composition and subsequently contacted with an etchant composition, the etchant composition exhibits a selectivity of the silicon germanium component to the silicon component of 30 to 300.
Aspect 10. The pretreatment composition according to any one of Aspects 1-9, wherein, when a substrate comprising a silicon component and a silicon germanium component is contacted with the pretreatment composition and subsequently contacted with an etchant composition, the etchant composition exhibits a selectivity of the silicon germanium component to the silicon component of 100 to 300.
Aspect 11. A kit for selectively etching silicon germanium comprising:
   a pretreatment composition,
      wherein the pretreatment composition comprises:
         a water;
         an acid component;
         an inhibitor; and
         1% to 20% by weight of a silane coupling agent based on a total weight of the pretreatment composition; and
   an etchant composition;
   wherein, when a substrate comprising a silicon component and a silicon germanium component is contacted with the pretreatment composition and subsequently contacted with the etchant composition, the etchant composition exhibits a selectivity of the silicon germanium component to the silicon component of at least 30.
Aspect 12. The kit according to Aspect 11, wherein the pretreatment composition has a pH of 4 to 7.
Aspect 13. The kit according to any one of Aspects 11-12, wherein the pretreatment composition comprises 0.1% to 10% by weight of the acid component based on the total weight of the pretreatment composition.
Aspect 14. The kit according to any one of Aspects 11-13, wherein the pretreatment composition comprises at least 60% by weight of the water based on a total weight of the pretreatment composition.
Aspect 15. The kit according to any one of Aspects 11-14, wherein the pretreatment composition comprises 1% to 10% by weight of the silane coupling agent based on the total weight of the pretreatment composition.
Aspect 16. The kit according to any one of Aspects 11-15, wherein the inhibitor comprises at least one of a nitride inhibitor, an oxide inhibitor, or any combination thereof.
Aspect 17. The kit according to any one of Aspects 11-16, wherein in the inhibitor comprises at least one of a polyethylenimine, a polyethylene, a polyvinylpyrrolidone, a silicic acid, a polyethylene glycol, a polypropylene glycol, a quaternary ammonium compound, a benzotriazole, a pyridine, a pyrazole, or any combination thereof.
Aspect 18. A method for selectively etching silicon germanium comprising:
   obtaining a pretreatment composition,
      wherein the pretreatment composition comprises:
         a water;
         an acid component;
         an inhibitor; and
         1% to 20% by weight of a silane coupling agent based on a total weight of the pretreatment composition; and
   obtaining an etchant composition;
   contacting the pretreatment composition with a substrate comprising a silicon germanium component and a silicon component; and
   after contacting the substrate with the pretreatment composition, contacting the substrate with the etchant composition.
Aspect 19. The method according to Aspect 18, wherein the etchant composition exhibits a selectivity of the silicon germanium component to the silicon component of at least 30.
Aspect 20. The method according to any one of Aspects 18-19, wherein the etchant composition exhibits a selectivity of the silicon germanium component to the silicon component of 30 to 300.

What is claimed is:

1. A pretreatment composition comprising:
a water;
an acid component;
an inhibitor; and
1% to 20% by weight of a silane coupling agent based on a total weight of the pretreatment composition;
wherein, when a substrate comprising a silicon component and a silicon germanium component is contacted with the pretreatment composition and subsequently contacted with an etchant composition, the etchant composition exhibits a selectivity of the silicon germanium component to the silicon component of at least 30.

2. The pretreatment composition of claim 1, wherein the pretreatment composition has a pH of 4 to 7.

3. The pretreatment composition of claim 1, wherein the pretreatment composition comprises 0.1% to 10% by weight of the acid component based on the total weight of the pretreatment composition.

4. The pretreatment composition of claim 1, wherein the pretreatment composition comprises at least 60% by weight of the water based on a total weight of the pretreatment composition.

5. The pretreatment composition of claim 1, wherein the pretreatment composition comprises 1% to 10% by weight of the silane coupling agent based on the total weight of the pretreatment composition.

6. The pretreatment composition of claim 1, wherein the inhibitor comprises at least one of a nitride inhibitor, an oxide inhibitor, or any combination thereof.

7. The pretreatment composition of claim 1, wherein in the inhibitor comprises at least one of a polyethylenimine, a polyethylene, a polyvinylpyrrolidone, a silicic acid, a polyethylene glycol, a polypropylene glycol, a quaternary ammonium compound, a benzotriazole, a pyridine, a pyrazole, or any combination thereof.

8. The pretreatment composition of claim 1, wherein the silane coupling agent comprises at least one of methyltrimethoxysilane (MTMS), a 1,3-dimethyltetramethoxydisiloxane (MTMS dimer), a (3-aminopropyl)triethoxysilane, a mercaptomethyltrimethoxysilyl, a 7-octenyltrimethoxysilane, or any combination thereof.

9. The pretreatment composition of claim 1, wherein, when a substrate comprising a silicon component and a silicon germanium component is contacted with the pretreatment composition and subsequently contacted with an etchant composition, the etchant composition exhibits a selectivity of the silicon germanium component to the silicon component of 30 to 300.

10. The pretreatment composition of claim 1, wherein, when a substrate comprising a silicon component and a silicon germanium component is contacted with the pretreatment composition and subsequently contacted with an etchant composition, the etchant composition exhibits a selectivity of the silicon germanium component to the silicon component of 100 to 300.

11. A kit for selectively etching silicon germanium comprising:
a pretreatment composition,
wherein the pretreatment composition comprises:
a water;
an acid component;
an inhibitor; and
1% to 20% by weight of a silane coupling agent based on a total weight of the pretreatment composition; and
an etchant composition;
wherein, when a substrate comprising a silicon component and a silicon germanium component is contacted with the pretreatment composition and subsequently contacted with the etchant composition, the etchant composition exhibits a selectivity of the silicon germanium component to the silicon component of at least 30.

12. The kit of claim 11, wherein the pretreatment composition has a pH of 4 to 7.

13. The kit of claim 11, wherein the pretreatment composition comprises 0.1% to 10% by weight of the acid component based on the total weight of the pretreatment composition.

14. The kit of claim 11, wherein the pretreatment composition comprises at least 60% by weight of the water based on a total weight of the pretreatment composition.

15. The kit of claim 11, wherein the pretreatment composition comprises 1% to 10% by weight of the silane coupling agent based on the total weight of the pretreatment composition.

16. The kit of claim 11, wherein the inhibitor comprises at least one of a nitride inhibitor, an oxide inhibitor, or any combination thereof.

17. The kit of claim 11, wherein in the inhibitor comprises at least one of a polyethylenimine, a polyethylene, a polyvinylpyrrolidone, a silicic acid, a polyethylene glycol, a polypropylene glycol, a quaternary ammonium compound, a benzotriazole, a pyridine, a pyrazole, or any combination thereof.

18. A method for selectively etching silicon germanium comprising:
obtaining a pretreatment composition,
wherein the pretreatment composition comprises:
a water;
an acid component;
an inhibitor; and
1% to 20% by weight of a silane coupling agent based on a total weight of the pretreatment composition; and
obtaining an etchant composition;
contacting the pretreatment composition with a substrate comprising a silicon germanium component and a silicon component; and
after contacting the substrate with the pretreatment composition, contacting the substrate with the etchant composition.

19. The method of claim 18, wherein the etchant composition exhibits a selectivity of the silicon germanium component to the silicon component of at least 30.

20. The method of claim 18, wherein the etchant composition exhibits a selectivity of the silicon germanium component to the silicon component of 30 to 300.
